(19) United States
(12) Patent Application Publication
(10) Pub. No.: US 2026/0323679 A1
(43) Pub. Date: Oct. 15, 2026

(54) COMMUNICATION DEVICES AND METHODS FOR COMMUNICATIONS

(71) Applicant: Lenovo (Beijing) Limited, Beijing (CN)

(72) Inventors: Mingzeng Dai, Shanghai (CN); Jing Han, Beijing (CN); Congchi Zhang, Shanghai (CN); Lianhai Wu, Beijing (CN)

(73) Assignee: Lenovo (Beijing) Limited, Beijing (CN)

(21) Appl. No.: 19/485,532

(22) PCT Filed: Jun. 6, 2023
(86) PCT No.: PCT/CN2023/098711

§ 371 Date: Nov. 18, 2025

(51) Int. Cl. H04W 72/542; H04W 72/04

(52) U.S. Cl. CPC H04W 72/542; H04W 72/04

(57) ABSTRACT

Embodiments of the present disclosure relate to a solution for communications. In one aspect of the solution, a first terminal device receives, from a second terminal device performing sidelink transmission to the first terminal device, second QoE information about the second terminal device. The second QoE information at least comprises an identifier (ID) of the second terminal device. Then, the first terminal device transmits, to a first network device, the second QoE information. The first terminal device also information at least comprising an identifier (ID) of the second terminal transmits, to the first network device, first QoE information about the first terminal device. The first QoE information comprises QoE measurement capability of the first terminal device. In turn, the first terminal device receives, from the first network device, first configuration information about a QoE measurement, the first configuration information comprising a first indication indicating the QoE measurement is for the sidelink transmission.

### FIELD

Embodiments of the present disclosure generally relate to the field of communication, and in particular to communication devices and methods for communications.

### BACKGROUND

The Quality of Experience (QoE) Measurement Collection (QMC) function enables collection of application layer measurements from user equipment (UE). Radio Access Network (RAN) visible QoE (RVQoE) measurements are also supported, where a subset of configured QoE metrics is reported from the UE to a gNB as an explicit information element (IE) readable by the gNB.

New Radio (NR) sidelink (SL) communication was introduced in Release 16. Support of Vehicle-to-Everything (V2X) services via the PC5 interface can be provided by NR sidelink communication. NR sidelink communication may be used to support other services than V2X services.

QoE measurement over sidelink has not been supported yet. In order to improve user experience using NR sidelink communication and optimize sidelink performance (for example, optimize radio resource selection), it makes sense to support QMC function as well as RVQoE measurement over sidelink.

### SUMMARY

In general, embodiments of the present disclosure provide a solution for communications.

In a first aspect, there is provided a first terminal device. The first terminal device comprises a processor and a transceiver coupled to the processor. The processor is configured to: receive, via the transceiver from a second terminal device performing sidelink transmission to the first terminal device, second QoE information about the second terminal device, the second QoE information at least comprising an identifier (ID) of the second terminal device; transmit, via the transceiver to a first network device, the second QoE information; transmit, via the transceiver to the first network device, first QoE information about the first terminal device, the first QoE information comprising QoE measurement capability of the first terminal device; and receive, via the transceiver from the first network device, first configuration information about a QoE measurement, the first configuration information comprising a first indication indicating the QoE measurement is for the sidelink transmission.

In a second aspect, there is provided a first network device. The first network device comprises a processor and a transceiver coupled to the processor. The processor is configured to: obtain, via the transceiver, second configuration information about a QoE measurement, the second configuration information comprising a first indication indicating the QoE measurement is for sidelink transmission; receive, via the transceiver from a first terminal device, first QoE information about the first terminal device, the first QoE information comprising QoE measurement capability of the first terminal device; receive, via the transceiver from the first terminal device, second QoE information about a second terminal device, the second terminal device performing the sidelink transmission to the first terminal device, the second QoE information at least comprising an identifier (ID) of the second terminal device; determine the first terminal device for the QoE measurement based on at least one of the second configuration information, the first QoE information or the second QoE information; and transmit, via the transceiver to the first terminal device, first configuration information about the QoE measurement, the first configuration information comprising the first indication.

In a third aspect, there is provided a second network device. The second network device comprises a processor and a transceiver coupled to the processor. The processor is configured to: receive, via the transceiver from a first network device or a second terminal device, a report of a QoE measurement for sidelink transmission from the second terminal device to a first terminal device, the second network device and the first network device serving the second terminal device and the first terminal device, respectively.

In a fourth aspect, there is provided a second terminal device. The second terminal device comprises a processor and a transceiver coupled to the processor. The processor is configured to: receive, via the transceiver from a network device or a first terminal device, a report of a QoE measurement for sidelink transmission from the second terminal device to the first terminal device.

In a fifth aspect, there is provided a first terminal device. The first terminal device comprises a processor and a transceiver coupled to the processor. The processor is configured to: receive a broadcast message via the transceiver from a first network device, the broadcast message comprising first configuration information about a QoE measurement, the first configuration information comprising a first indication indicating the QoE measurement is for the sidelink transmission; determine to perform the QoE measurement based on the first configuration information; and transmit a dedicated signaling via the transceiver to the first network device, the dedicated signaling comprising a report of the QoE measurement.

In a sixth aspect, there is provided a first network device. The first network device comprises a processor and a transceiver coupled to the processor. The processor is configured to: transmit a broadcast message via the transceiver, the broadcast message comprising first configuration information about a QoE measurement, the first configuration information comprising a first indication indicating the QoE measurement is for the sidelink transmission; and receive a dedicated signaling via the transceiver from a first terminal device, the dedicated signaling comprising a report of the QoE measurement.

In a seventh aspect, there is provided a method performed by a first terminal device. The method comprises: receiving, from a second terminal device performing sidelink transmission to the first terminal device, second QoE information about the second terminal device, the second QoE information at least comprising an identifier (ID) of the second terminal device; transmitting, to a first network device, the second QoE information; transmitting, to the first network device, first QoE information about the first terminal device, the first QoE information comprising QoE measurement capability of the first terminal device; and receiving, from the first network device, first configuration information about a QoE measurement, the first configuration information comprising a first indication indicating the QoE measurement is for the sidelink transmission.

In an eighth aspect, there is provided a method performed by a first network device. The method comprises: obtaining second configuration information about a QoE measurement, the second configuration information comprising a first indication indicating the QoE measurement is for sidelink transmission; receiving, from a first terminal device, first QoE information about the first terminal device, the first QoE information comprising QoE measurement capability of the first terminal device; receiving, from the first terminal device, second QoE information about a second terminal device, the second terminal device performing the sidelink transmission to the first terminal device, the second QoE information at least comprising an ID of the second terminal device; determining the first terminal device for the QoE measurement based on at least one of the second configuration information, the first QoE information or the second QoE information; and transmitting, to the first terminal device, first configuration information about the QoE measurement, the first configuration information comprising the first indication.

In a ninth aspect, there is provided a method performed by a second network device. The method comprises: receiving, from a first network device or a second terminal device, a report of a QoE measurement for sidelink transmission from the second terminal device to a first terminal device, the second network device and the first network device serving the second terminal device and the first terminal device, respectively.

In a tenth aspect, there is provided a method performed by a second terminal device. The method comprises: receiving, from a network device or a first terminal device, a report of a QoE measurement for sidelink transmission from the second terminal device to the first terminal device.

In an eleventh aspect, there is provided a method performed by a first terminal device. The method comprises: receiving a broadcast message from a first network device, the broadcast message comprising first configuration information about a QoE measurement, the first configuration information comprising a first indication indicating the QoE measurement is for the sidelink transmission; determining to perform the QoE measurement based on the first configuration information; and transmitting a dedicated signaling to the first network device, the dedicated signaling comprising a report of the QoE measurement.

In a twelfth aspect, there is provided a method performed by a first network device. The method comprises: transmitting a broadcast message via the transceiver, the broadcast message comprising first configuration information about a QoE measurement, the first configuration information comprising a first indication indicating the QoE measurement is for the sidelink transmission; and receiving a dedicated signaling from a first terminal device, the dedicated signaling comprising a report of the QoE measurement.

In a thirteenth aspect, there is provided a computer readable medium. The computer readable medium has instructions stored thereon. The instructions, when executed on at least one processor of a device, causing the device to perform the method of any of the seventh, the eighth, the ninth, the tenth, the eleventh or the twelfth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings in which:

FIGS. 1A and 1B illustrate a schematic diagram of a communication environment in which some embodiments of the present disclosure can be implemented, respectively;

FIG. 2 illustrates a signaling chart illustrating an example process for communications in accordance with some embodiments of the present disclosure;

FIG. 3 illustrates a signaling chart illustrating an example process for communications in accordance with some other embodiments of the present disclosure;

FIG. 4 illustrates a signaling chart illustrating an example process for communications in accordance with still other embodiments of the present disclosure;

FIG. 5 illustrates a signaling chart illustrating an example process for communications in accordance with yet other embodiments of the present disclosure;

FIG. 6 illustrates a flowchart of a method implemented at a first terminal device in accordance with some embodiments of the present disclosure;

FIG. 7 illustrates a flowchart of a method implemented at a first network device in accordance with some embodiments of the present disclosure;

FIG. 8 illustrates a flowchart of a method implemented at a second network device in accordance with some embodiments of the present disclosure;

FIG. 9 illustrates a flowchart of a method implemented at a second terminal device in accordance with some embodiments of the present disclosure;

FIG. 10 illustrates a flowchart of a method implemented at a first terminal device in accordance with some embodiments of the present disclosure;

FIG. 11 illustrates a flowchart of a method implemented at a first network device in accordance with some embodiments of the present disclosure; and

FIG. 12 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication environment” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IOT), and so on. Further, the communications between a terminal device and a network device in the communication environment may be performed according to any suitable generation communication protocols, including but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication environment via which a terminal device can access the communication environment and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a vehicle-to-everything (V2X) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As described above, QoE measurement over sidelink has not been supported yet. In order to improve user experience using NR sidelink communication and optimize sidelink performance (for example, optimize radio resource selection), it makes sense to support QMC function as well as RVQoE measurement over sidelink.

In order to support QMC function over sidelink, some issues may need to be solved. For example, how to support that QoE measurement configuration and report transmitted between a destination gNB (D-gNB) and a destination UE (D-UE) directly needs to be solved.

In view of the above, embodiments of the present disclosure provide a solution for communications. In this solution, a first terminal device receives, from a second terminal device performing sidelink transmission to the first terminal device, second QoE information about the second terminal device. The second QoE information at least comprises an identifier (ID) of the second terminal device. Then, the first terminal device transmits, to a first network device, the second QoE information. The first terminal device also transmits, to the first network device, first QoE information about the first terminal device. The first QoE information comprises QoE measurement capability of the first terminal device. In turn, the first terminal device receives, from the first network device, first configuration information about a QoE measurement, the first configuration information comprising a first indication indicating the QoE measurement is for the sidelink transmission.

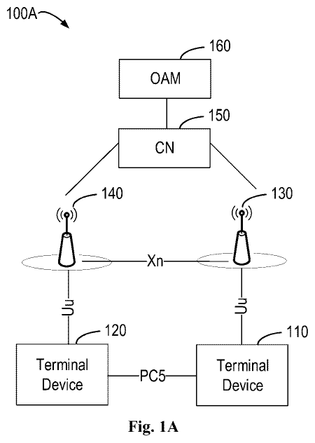

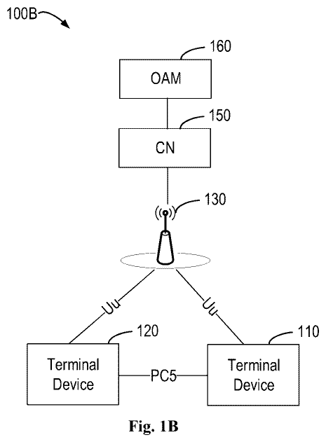

Hereinafter, principle of the present disclosure will be described with reference to FIGS. 1A to 12.

FIG. 1A illustrates a schematic diagram of a communication environment 100A in which some embodiments of the present disclosure can be implemented. As shown in FIG. 1A, the communication environment 100A may include a first terminal device 110, a second terminal device 120, a first network (NW) device 130, a second network device 140, a core network (CN) 150 and OAM 160. The first network device 130 and the second network device 140 serve the first terminal device 110 and the second terminal device 120, respectively. In other words, the first terminal device 110 and the second terminal device 120 are connected to different network devices, i.e., the first network device 130 and the second network device 140, respectively.

In some embodiments, each of the first network device 130 and the second network device 140 may be a gNB in NR or an eNB in Long Term Evolution (LTE) system.

FIG. 1B illustrates a schematic diagram of a communication environment 100B in which some embodiments of the present disclosure can be implemented. The communication environment 100B is similar to the communication environment 100A. The communication environment 100B is different from the communication environment 100A in that the first network device 130 serves both the first terminal device 110 and the second terminal device 120. In other words, both the first terminal device 110 and the second terminal device 120 are connected to the same network device, i.e., the first network device 130.

It is to be understood that the number of devices in FIGS. 1A and 1B is given for the purpose of illustration without suggesting any limitations to the present disclosure. The communication environments 100A and 100B may include any suitable number of network devices and/or terminal devices adapted for implementing embodiments of the present disclosure.

The communications in the communication environments 100A and 100B may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication environments 100A and 100B may comprise cellular network communication. In the cellular network communication, for example, the first terminal device 110 may transmit data to the first network device 130 (i.e., uplink transmissions) or receive data from the first network device 130 (i.e., downlink transmissions).

In some embodiments, the communications in the communication environments 100A and 100B may comprise sidelink communication. Sidelink communication is a type of wireless communication directly between two or more terminal devices, such as two or more terminal devices among the first terminal device 110 and the second terminal device 120. In this type of communication, the two or more terminal devices that are geographically proximate to each other can directly communicate without going through the first network device 130, the second network device 140 or the CN 150.

Data transmission in sidelink communication is thus different from that in the cellular network communication. In the sidelink communication, data is transmitted directly from a source terminal device (also referred to as source UE or S-UE) to a destination terminal device (also referred to as destination UE or D-UE) over sidelink. Data transmission over sidelink is also referred to as sidelink transmission or sidelink data transmission. An interface between the source terminal device and destination terminal device may comprise a PC5 interface. In order to perform sidelink communication, a PC5 Radio Resource Control (RRC) connection may be established between the source terminal device and the destination terminal device.

In some embodiments, in order to improve user experience using the sidelink communication and optimize sidelink performance, it makes sense to support QMC function over sidelink.

In embodiments where the second terminal device 120 performs sidelink transmission to the first terminal device 110, the first terminal device 110 may perform QoE measurement for the sidelink transmission. Such QoE measurement may be referred to as QoE measurement for sidelink or QoE measurement over sidelink.

In turn, the first terminal device 110 may transmit a report of the QoE measurement for sidelink to the first network device 130. Further, the first network device 130 may forward the report of the QoE measurement for sidelink to the CN 150 or to the OAM 160 via the CN 150. In this way, user experience using the sidelink communication may be improved based on the report.

In some embodiments, the first network device 130 may forward the report of the QoE measurement for sidelink to the second network device 140. The second network device 140 may forward the report of the QoE measurement for sidelink to the second terminal device 120. In this way, at least one of the second network device 140 and the second terminal device 120 may use the report of the QoE measurement for radio resource optimization.

In some embodiments, the first terminal device 110 may transmit the report of the QoE measurement for sidelink to the second terminal device 120. The second terminal device 120 may forward the report of the QoE measurement for sidelink to the second network device 140. In this way, at least one of the second network device 140 and the second terminal device 120 may use the report of the QoE measurement for radio resource optimization.

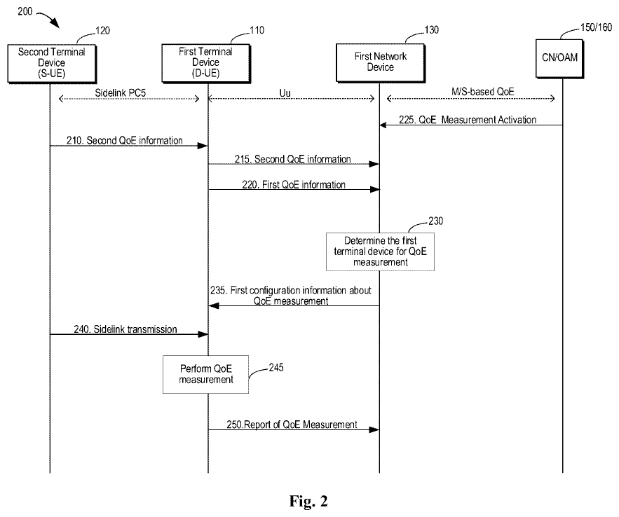

FIG. 2 illustrates a signaling chart illustrating an example process 200 for communications in accordance with some embodiments of the present disclosure. For the purpose of discussion, the process 200 will be described with reference to FIG. 1A or 1B. The process 200 may involve the first terminal device 110, the second terminal device 120, the first network device 130, the CN 150 and the OAM 160.

Generally, in the process 200, the second terminal device 120 performs sidelink transmission to the first terminal device 110. Thus, for brevity, the second terminal device 120 is also referred to as a source terminal device or S-UE 120, and the first terminal device 110 is also referred to as a destination terminal device or D-UE 110.

Specifically, the second terminal device 120 transmits 210 second QoE information about the second terminal device 120 to the first terminal device 110.

In some embodiments, after PC5-RRC establishment and the exchange of UE capability, if both the second terminal device 120 and the first terminal device 110 support QoE measurement, the second terminal device 120 may transmit the second QoE information about the second terminal device 120 to the first terminal device 110.

In some embodiments, the first terminal device 110 may transmit to the second terminal device 120 a request for the second QoE information about the second terminal device 120 by PC-5 RRC message. Upon receiving the request, the second terminal device 120 transmits the second QoE information about the second terminal device 120 to the first terminal device 110.

In some embodiments, when the second terminal device 120 moves to a new cell (e.g., handover or cell reselection to a new cell), the second terminal device 120 provides the updated second QoE information about the second terminal device 120 to the first terminal device 110.

The second QoE information about the second terminal device 120 at least comprises an identifier (ID) of the second terminal device 120.

In some embodiments, the ID of the second terminal device 120 may comprise a Source Layer-2 ID that identifies the second terminal device 120 in the sidelink.

Alternatively, in some embodiments, the ID of the second terminal device 120 may comprise a user information ID. The user information ID may be configured for Model A or Model B Group Member Discovery and 5G proximity based services (ProSe) UE-to-Network Relay Discovery either for public safety or commercial applications based on policy of a home public land mobile network (HPLMN) or via a ProSe application server that allocates it.

Alternatively, in some embodiments, the ID of the second terminal device 120 may comprise a source UE ID that is used in Uu interface in a serving cell of the second terminal device 120. For example, the source UE ID may be a cell radio network temporary identifier (C-RNTI) of the second terminal device 120 in a serving primary cell (PCell).

In some embodiments, the second QoE information may further comprise at least one of the following:
an ID of a serving cell of the second terminal device 120,
a fourth indication of a radio resource control (RRC) state of the second terminal device 120,
a resource allocation mode of the second terminal device 120, or
a fifth indication indicating whether a signaling radio bearer (SRB) for a report of the QoE measurement is available between the second terminal device 120 and the second network device 140 serving the second terminal device 120.

In some embodiments, the ID of the serving cell of the second terminal device 120 may comprise an NR Cell ID of a serving PCell or NR Cell Global ID (NCGI).

In some embodiments, the fourth indication of the RRC state of the second terminal device 120 may indicate that the second terminal device 120 is in an RRC_CONNECTED state, RRC_INACTIVE state or RRC_IDLE state. Alternatively, or additionally, the fourth indication of the RRC state may indicate whether the second terminal device 120 is in RRC_CONNECTED state.

In some embodiments, the resource allocation mode of the second terminal device 120 may comprise mode 1 of scheduling mode or mode 2 of autonomous resource allocation mode.

With continued reference to FIG. 2, the first terminal device 110 transmits 215 the second QoE information to the first network device 130.

In some embodiments, the first terminal device 110 may transmit a SidelinkUEInformation message to the first network device 130. The SidelinkUEInformation message may comprise the second QoE information.

In some embodiments, upon receiving the second QoE information about the second terminal device 120, the first terminal device 110 transmits 215 the second QoE information to the first network device 130.

Alternatively, in some embodiments, the first network device 130 may transmit to the first terminal device 110 a request for the second QoE information. Upon receiving the request, the first terminal device 110 transmits the second QoE information to the first network device 130.

In addition, the first terminal device 110 transmits 220 first QoE information about the first terminal device 110 to the first network device 130. The first QoE information comprises QoE measurement capability of the first terminal device 110.

In some embodiments, the first terminal device 110 may transmit a SidelinkUEInformation message to the first network device 130. The SidelinkUEInformation message may comprise the first QoE information.

In some embodiments, the first terminal device 110 may transmit the first QoE information together with the second QoE information. Alternatively, the first terminal device 110 may transmit the first QoE information separate from the second QoE information.

In some embodiments, the QoE measurement capability of the first terminal device 110 may indicate whether the first terminal device 110 supports QoE measurement over sidelink as a destination UE.

Alternatively, or additionally, the QoE measurement capability of the first terminal device 110 may indicate whether the first terminal device 110 supports QoE measurement over sidelink as a destination UE for a service type. For example, the service type may comprise at least one of the following: a streaming service, Multimedia Telephony Service for IP Multimedia Subsystem (MTSI) service, or Augmented Reality (AR) service.

Alternatively, or additionally, the QoE measurement capability of the first terminal device 110 may indicate whether the first terminal device 110 supports RVQUE measurement over sidelink as a destination UE for a service type, such as a streaming service.

In some embodiments, different service types may be differentiated by different Layer-2 IDs. In such embodiments, the QoE measurement capability of the first terminal device 110 may comprise an ID of the first terminal device 110 if the ID of the first terminal device 110 is for a specific service type. In this way, the first network device 130 can distinguish the service type by the ID of the first terminal device 110.

The first network device 130 receives 225 a QoE measurement activation message from the CN 150 or OAM 160.

In some embodiments, QMC function may be activated in the first network device 130 by direct configuration from the OAM 160. In such embodiments, the activation may be referred to as management-based activation and QoE measurement may be referred to as management-based QoE measurement. In such embodiments, the first network device 130 may receive the QoE measurement activation message from the OAM 160.

Alternatively, in some embodiments, the QMC function may be activated in the first network device 130 by signalling from the OAM 160 via the CN 150. In such embodiments, the activation may be referred to as signalling-based activation and QoE measurement may be referred to as signalling-based QoE measurement. In such embodiments, the first network device 130 may receive the QoE measurement activation message from the CN 150 by means of UE-associated signalling.

The QoE measurement activation message may comprise second configuration information about the QoE measurement. The second configuration information comprises a first indication indicating the QoE measurement is for sidelink. Hereinafter, for the purpose of discussion, the first indication is also referred to as a sidelink QoE measurement indication.

In some embodiments, the sidelink QoE measurement indication may comprise a dedicated indicator indicating the QoE measurement is for sidelink.

Alternatively, in some embodiments, the sidelink QoE measurement indication may comprise a service type indicating the QoE measurement is for sidelink. In other words, the sidelink QoE measurement indication may be implicitly indicated by a dedicated or new service type. For example, the new service type may be a sidelink service type.

In some embodiments, the second configuration information may comprise a second application layer measurement configuration list. The second application layer measurement configuration list may comprise one or more application layer measurement configurations.

In some embodiments, the second configuration information may also comprise information for QoE measurement collection associated with each of the one or more application layer measurement configurations. For example, information for QoE measurement collection associated with the first application layer measurement configuration may comprise at least one of the following: QoE reference, a service type, an area scope, a Measurement Collection Entity (MCE) Internet Protocol (IP) address, a slice scope, Minimization of Drive Test (MDT) alignment information and an indication of available RAN visible QoE metrics.

Upon receiving the second configuration information, the first QoE information and the second QoE information, the first network device 130 selects 230 one of source terminal devices for the QoE measurement based on at least one of the second configuration information, the first QoE information or the second QoE information. In the process 200, it is assumed that the first network device 130 selects the first terminal device 110 for the QoE measurement. In other words, the first network device 130 determines the first terminal device 110 for the QoE measurement.

In some embodiments, the first network device 130 may select one of source terminal devices for the QoE measurement based on the first QoE information about the first terminal device 110 and the sidelink QoE measurement indication in the second configuration information from the OAM 160 or CN 150. When selecting a terminal device for the QoE measurement, the first network device 130 may consider the QoE measurement capability of the terminal device, for example, whether the terminal device supports QoE measurement over sidelink as a destination UE for a service type.

For example, the first network device 130 only selects the terminal device that supports QoE measurement over sidelink as a destination UE for the service type.

For another example, the first network device 130 may also consider a serving cell of the second terminal device 120. For example, if the serving cell of the second terminal device 120 is not served by the first network device 130, the first network device 130 shall not select the first terminal device 110 for the QoE measurement.

For a further example, the first network device 130 may also consider the RRC state of the second terminal device 120. If the second terminal device 120 is not in the RRC_CONNECTED state, the first network device 130 shall not select the first terminal device 110 for the QoE measurement.

In turn, the first network device 130 transmits 235, to the first terminal device 110, first configuration information about the QoE measurement. The first configuration information comprises the first indication indicating the QoE measurement is for sidelink transmission.

In some embodiments, the first configuration information about the QoE measurement may comprise an ID of the first terminal device 110. For example, the ID of the first terminal device 110 may comprise a Destination Layer-2 ID of the first terminal device 110.

Alternatively, or additionally, in some embodiments, the first configuration information about the QoE measurement may comprise the ID of the second terminal device 120. For example, the ID of the second terminal device 120 may comprise a Source Layer-2 ID that identifies the second terminal device 120 in the sidelink, a user information ID, or a source UE ID that is used in Uu interface in a serving cell of the second terminal device 120.

Alternatively, or additionally, in some embodiments, the first configuration information about the QoE measurement may comprise a sidelink service type associated with the QoE measurement.

Alternatively, or additionally, in some embodiments, the first configuration information about the QoE measurement may comprise an ID identifying the QoE measurement. In some embodiments, the ID identifying the QoE measurement may comprise an RRC ID (i.e., measConfigApplayerId) of the QoE measurement used for sidelink interface that is used to identify the QoE measurement over sidelink interface. The RRC ID of the QoE measurement used for sidelink interface may be allocated by the first network device 130 or by the first terminal device 110.

Alternatively, or additionally, in some embodiments, the first configuration information about the QoE measurement may comprise at least one of the following: an application layer measurement configuration for the QoE measurement, or an RAN visible configuration for the QoE measurement.

The second terminal device 120 performs 240 sidelink transmission to the first terminal device 110.

The first terminal device 110 performs 245 the QoE measurement for the sidelink transmission based on the first configuration information about the QoE measurement.

In some embodiments, if the QoE measurement is per service type, it is possible that the first terminal device 110 has multiple sidelink connections with multiple UEs in which case the first terminal device 110 has multiple UE IDs. Each of the multiple UE IDs is associated with one of the multiple sidelink connections.

In such embodiments, when the first terminal device 110 receives the first configuration information about the QoE measurement, the first terminal device 110 may measure the service with the pointed second terminal device 120. In this case, the first network device 130 needs to provide the ID of the first terminal device 110 that connects to the pointed second terminal device 120 in the first configuration information.

Alternatively, the first terminal device 110 may measure the same service running with all connected terminal devices related with the sidelink service type. For example, the first terminal device 110 has sidelink connections with the second terminal device 120 and a third terminal device. A streaming service is running between the first terminal device 110 and the second terminal device 120 and the streaming service is running between the first terminal device 110 and the third terminal device. Thus, the first terminal device 110 may perform QoE measurement for sidelink transmissions associated with the streaming service from the second terminal device 120 and the third terminal device. In this case, the first configuration information may not comprise the ID of the first terminal device 110 ID. Instead, the first network device 130 may indicate the sidelink service type to be measured in the first configuration information.

In turn, the first terminal device 110 may transmit 250 a report of the QoE measurement to the first network device 130. Alternatively, the first terminal device 110 may transmit the report of the QoE measurement to the second terminal device 120.

In some embodiments, if the first configuration information about the QoE measurement comprises an application layer measurement configuration for the QoE measurement, the report of the QoE measurement may comprise a first QoE measurement report associated with the application layer measurement configuration for the QoE measurement.

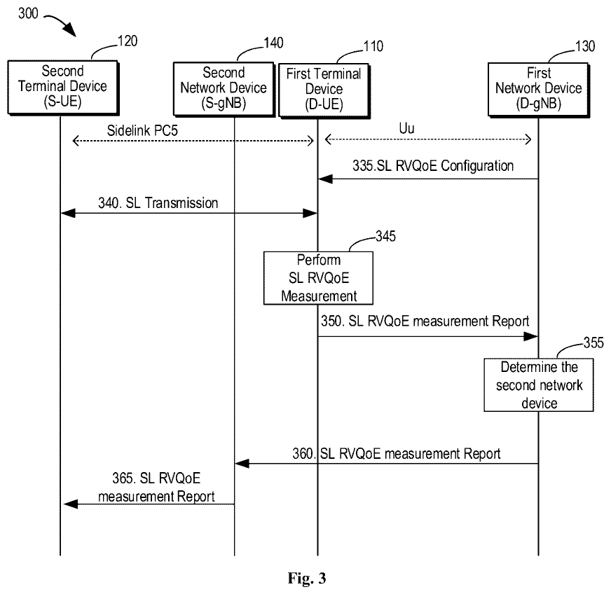

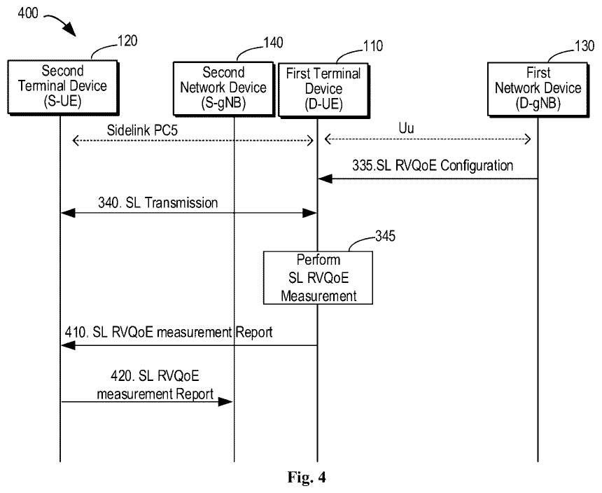

Alternatively, or additionally, in some embodiments, if the first configuration information about the QoE measurement comprises an RAN visible configuration for the QoE measurement, the report of the QoE measurement may comprise a second QoE measurement report associated with the RAN visible configuration for the QoE measurement. This will be described with reference to FIGS. 3 and 4.

FIG. 3 illustrates a signaling chart illustrating an example process 300 for communications in accordance with some embodiments of the present disclosure. The process 300 may be considered as an example implementation of the method 200. For the purpose of discussion, the process 300 will be described with reference to FIG. 1B. The process 300 may involve the first terminal device 110, the second terminal device 120, the first network device 130 and the second network device 140.

Generally, similar to the process 200, in the process 300, the second terminal device 120 acts as a source terminal device or S-UE 120, and the first terminal device 110 acts as a destination terminal device or D-UE 110. The first terminal device 110 and the second terminal device 120 are connected to the first network device 130 and the second network device 140, respectively. For brevity, the first network device 130 and the second network device 140 may be referred to as D-gNB and S-gNB, respectively.

In the process 300, the first network device 130 transmits RAN visible configuration for QoE measurement to the first terminal device 110 directly by an RRC dedicated signaling. The first terminal device 110 transmits, to the first network device 130, a second QoE measurement report associated with the RAN visible configuration for the QoE measurement. Hereinafter, for brevity, the RAN visible configuration for QoE measurement is also referred to as SL RVQoE configuration. The second QoE measurement report is also referred to as SL RVQoE measurement report. In order to use the SL RVQUE measurement report for radio resource optimization in source side, the first network device 130 needs to route the SL RVQoE measurement report to the source side (i.e., the second network device 140).

The process 300 may comprise actions 210, 215, 220, 225 and 230 as described with reference to FIG. 2. Details of are actions 210, 215, 220, 225 and 230 are omitted for brevity.

Specifically, as shown in FIG. 3, the first network device 130 transmits 335 the SL RVQoE configuration to the first terminal device 110.

In some embodiments, the SL RVQoE configuration may comprise a subset of configured QoE metrics included in the application layer measurement configuration for the QoE measurement.

The second terminal device 120 performs 340 sidelink transmission to the first terminal device 110.

The first terminal device 110 performs 345 an SL RVQoE measurement for the sidelink transmission based on the SL RVQoE configuration.

In some embodiments, the first terminal device 110 may receive, from the first network device 130, a third indication indicating that an SL RVQoE measurement report is to be transmitted to the first network device 130. In such embodiments, when an SL RVQoE measurement report is available in the first terminal device 110, the first terminal device 110 transmits 350 the SL RVQoE measurement report to the first network device 130 based on the third indication.

In some embodiments, the SL RVQoE measurement report may comprise one of the following: a sidelink Quality of Service (QoS) flow ID associated with the SL RVQoE measurement report, or a sidelink radio bearer (RB) ID associated with the SL RVQoE measurement report.

In addition, the first terminal device 110 may transmit the second QoE information about the second terminal device 120 to the first network device 130. For example, the first terminal device 110 may transmit the second QoE information together with the SL RVQoE measurement report. Alternatively, the first terminal device 110 may transmit the second QoE information before transmitting the SL RVQoE measurement report.

The second QoE information about the second terminal device 120 at least comprises the ID of the second terminal device 120.

In some embodiments, the ID of the second terminal device 120 may comprise a Source Layer-2 ID that identifies the second terminal device 120 in the sidelink.

Alternatively, in some embodiments, the ID of the second terminal device 120 may comprise a user information ID.

Alternatively, in some embodiments, the ID of the second terminal device 120 may comprise a source UE ID that is used in Uu interface in a serving cell of the second terminal device 120. For example, the source UE ID may be a C-RNT of the second terminal device 120 in a serving PCell. In case the second terminal device 120 is in RRC INACTIVE state, the source UE ID used in Uu interface is I-RNTI. If the second terminal device 120 is in the RRC_IDLE state, the source UE ID used in Uu interface is not present.

In some embodiments, the second QoE information may further comprise at least one of the following:
the ID of a serving cell of the second terminal device 120,
the fourth indication of the RRC state of the second terminal device 120,
the resource allocation mode of the second terminal device 120, or
the fifth indication indicating whether an SRB for the report of the QoE measurement is available between the second terminal device 120 and the second network device 140 serving the second terminal device 120.

In turn, the first network device 130 determines 355 the second network device 140 serving the second terminal device 120 based on the second QoE information about the second terminal device 120. For example, the first network device 130 may determine the second network device 140 based on the ID of the serving cell of the second terminal device 120.

Then, the first network device 130 transmits 360 the SL RVQoE measurement report to the second network device 140.

In some embodiments, the first network device 130 may transmit an RRC container (i.e., inter-node RRC message) to the second network device 140. The RRC container may comprise the SL RVQoE measurement report.

In some embodiments, the first network device 130 may transmit, to the second network device 140, UE associated or non-UE associated Xn-AP signaling which comprises the SL RVQoE measurement report.

In some embodiments, the first network device 130 may transmit the SL RVQoE measurement report together with the second QoE information about the second terminal device 120. For example, the second QoE information may comprise the source UE ID used in Uu interface and the ID of the serving cell of the second terminal device 120.

Upon receiving the SL RVQoE measurement report, the second network device 140 may use the SL RVQoE measurement report to optimize the radio resource for sidelink.

In some embodiments, the second network device 140 may also forward 365 the SL RVQoE measurement report to the second terminal device 120.

FIG. 4 illustrates a signaling chart illustrating an example process 400 for communications in accordance with some embodiments of the present disclosure. The process 400 may be considered as another example implementation of the method 200. For the purpose of discussion, the process 400 will be described with reference to FIG. 1B. The process 400 may involve the first terminal device 110, the second terminal device 120, the first network device 130 and the second network device 140.

Generally, similar to the process 300, in the process 400, the second terminal device 120 acts as a source terminal device or S-UE 120, and the first terminal device 110 acts as a destination terminal device or D-UE 110. The first terminal device 110 and the second terminal device 120 are connected to the first network device 130 (i.e., D-gNB) and the second network device 140 (i.e., S-gNB), respectively.

In the process 400, the first network device 130 transmits SL RVQoE configuration to the first terminal device 110 directly by an RRC dedicated signaling. In order to use the SL RVQoE measurement report for radio resource optimization in source side, the first terminal device 110 transmits SL RVQoE measurement report to the second terminal device 120. The second terminal device 120 transmits the SL RVQoE measurement report to the second network device 140.

The process 400 may comprise actions 210, 215, 220, 225 and 230 as described with reference to FIG. 2. In addition, the process 400 may comprise actions 335, 340 and 345 as described with reference to FIG. 3. Details of are actions 210, 215, 220, 225, 230, 335, 340 and 345 are omitted for brevity.

Specifically, as shown in FIG. 4, the first terminal device 110 transmits 410 SL RVQoE measurement report to the second terminal device 120 via PC-5 RRC connection. The second terminal device 120 transmits 420 the SL RVQoE measurement report to the second network device 140.

In some embodiments, in order to support the SL RVQoE configuration (transmitted at 335), the second QoE information about the second terminal device 120 may comprise a fifth indication indicating whether a signaling radio bearer (SRB) for the SL RVQoE measurement report is available between the second terminal device 120 and the second network device 140. The SRB may be SRB4. For example, if SRB4 is available, the first network device130 may decide to transmit the SL RVQoE configuration to the first terminal device 110 and the SL RVQoE measurement report is transmitted from the first terminal device 110 to the second terminal device 120 over PC-5 RRC connection and then to the second network device 140 by SRB4.

In some embodiments, the first terminal device 110 receives, from the first network device 130 or the second terminal device 120, a second indication indicating that the SL RVQoE measurement report is to be transmitted to the second terminal device 120. Then, the first terminal device 110 transmits the SL RVQoE measurement report to the second terminal device 120 based on the second indication.

In some embodiments, the second QoE information about the second terminal device 120 may comprise a fourth indication of an RRC state of the second terminal device 120. The first terminal device 110 transmits, based on the fourth indication of the RRC state, the SL RVQoE measurement report to the second terminal device 120.

For example, if the fourth indication of the RRC state indicates that the second terminal device 120 is in RRC_CONNECTED state, the first terminal device 110 transmits the SL RVQoE measurement report to the second terminal device 120.

For another example, if the fourth indication of the RRC state indicates that the second terminal device 120 is in RRC_CONNECTED state, but SRB4 does not exist between the second terminal device 120 and the second network device 140, the second terminal device 120 may transmit a request for setup of SRB4 to the second network device 140 when the second terminal device 120 receives the SL RVQoE measurement report from the first terminal device 110 or when the second terminal device 120 is aware of the SL QoE measurement is configured to the first terminal device 110 by the first network device 130. When the second terminal device 120 is aware of the SL QoE measurement is configured to the first terminal device 110 by the first network device 130, the first terminal device 110 may inform the second terminal device 120 that the RVQoE measurement is configured when the first terminal device 110 receives the RVQoE measurement configuration from the first network device 130 at 335.

If the fourth indication of the RRC state indicates that the second terminal device 120 is in RRC INACTIVE state, the second terminal device 120 may store the SL RVQoE measurement report. When or after the second terminal device 120 performs RRC Resume procedure, the second terminal device 120 indicates the availability of SL RVQUE measurement report to the second network device 140, for example, in the RRCResumeRequest message. Then, the second network device 140 requests the second terminal device 120 transmits the SL RVQoE measurement report to the second network device 140.

If the fourth indication of the RRC state indicates that the second terminal device 120 is in RRC IDLE state, the second terminal device 120 may store the SL RVQoE measurement report. When or after the second terminal device 120 performs RRC Setup procedure, the second terminal device 120 indicates the availability of SL RVQoE measurement report to the second network device 140, for example, in the RRCRequest message or RRCSetupComplete message. Then, the second network device 140 requests the second terminal device 120 transmits the SL RVQoE measurement report to the second network device 140.

Upon receiving the SL RVQoE measurement report, the second network device 140 may use the SL RVQoE measurement report to optimize the radio resource for sidelink.

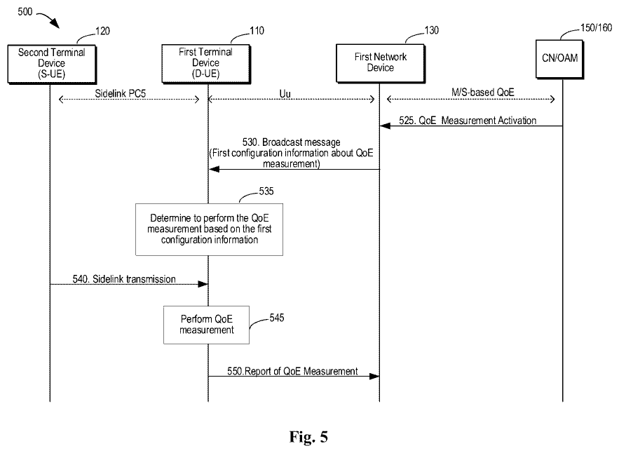

FIG. 5 illustrates a signaling chart illustrating an example process 500 for communications in accordance with some embodiments of the present disclosure. For the purpose of discussion, the process 500 will be described with reference to FIG. 1A or 1B. The process 500 may involve the first terminal device 110, the second terminal device 120, the first network device 130, the CN 150 and the OAM 160.

Generally, in the process 500, the second terminal device 120 performs sidelink transmission to the first terminal device 110. Thus, the second terminal device 120 acts as a source terminal device or S-UE 120, and the first terminal device 110 acts as a destination terminal device or D-UE 110. The first terminal device 110 and the second terminal device 120 may be connected to the first network device 130 and the second network device 140, respectively. Alternatively, both the first terminal device 110 and the second terminal device 120 may be connected to the first network device 130.

Specifically, the first network device 130 receives 525 a QoE measurement activation message from the CN 150 or OAM 160.

In some embodiments, QMC function may be activated in the first network device 130 by direct configuration from the OAM 160. In such embodiments, the activation may be referred to as management-based activation and QoE measurement may be referred to as management-based QoE measurement. In such embodiments, the first network device 130 may receive the QoE measurement activation message from the OAM 160.

Alternatively, in some embodiments, the QMC function may be activated in the first network device 130 by signalling from the OAM 160 via the CN 150. In such embodiments, the activation may be referred to as signalling-based activation and QoE measurement may be referred to as signalling-based QoE measurement. In such embodiments, the first network device 130 may receive the QoE measurement activation message from the CN 150 by means of UE-associated signalling.

The QoE measurement activation message may comprise second configuration information about the QoE measurement. The second configuration information comprises a first indication indicating the QoE measurement (i.e., sidelink QoE measurement indication) is for sidelink.

The first network device 130 transmits 530 a broadcast message. The broadcast message comprises first configuration information about a QoE measurement. Thus, if the first terminal device 110 is in RRC INACTIVE state or RRC IDLE state, the first terminal device 110 can receive the first configuration information about the QoE measurement. In some embodiments, if the first terminal device 110 is in RRC CONNECTED state, the first terminal device 110 can receive the first configuration information about the QoE measurement.

The first configuration information comprises the first indication indicating the QoE measurement is for the sidelink transmission.

In some embodiments, the first configuration information about the QoE measurement may further comprise an ID identifying the QoE measurement. In some embodiments, the ID identifying the QoE measurement may comprise an RRC ID (i.e., measConfigApplayerId) of the QoE measurement used for sidelink interface that is used to identify the QoE measurement over sidelink interface. The RRC ID of the QoE measurement used for sidelink interface may be allocated by the first network device 130 or by the first terminal device 110.

In some embodiments, the first configuration information about the QoE measurement may further comprise at least one of the following: an application layer measurement configuration for the QoE measurement, or an RAN visible configuration for the QoE measurement.

In some embodiments, the first network device 130 may transmit system information comprising the first configuration information about the QoE measurement.

In some embodiments, the first network device 130 may transmit the first configuration information about the QoE measurement by a group scheduling. For example, the first network device 130 may allocate a group Radio Network Temporary Identifier (G-RNTI) to all terminal devices or a group of terminal devices comprising the first terminal device 110. The first network device 130 transmit the first configuration information that is scrambled by the G-RNTI. The group of terminal devices comprising the first terminal device 110 monitor the G-RNTI for the first configuration information.

Upon receiving the first configuration information, the first terminal device 110 determines 535 to perform the QoE measurement based on the first configuration information.

The first terminal device 110 receives 540 sidelink transmission from the second terminal device 120.

In turn, the first terminal device 110 performs 545 the QoE measurement for the sidelink transmission based on the first configuration information about the QoE measurement.

Then, the first terminal device 110 transmits 550 a dedicated signaling to the first network device 130. The dedicated signaling comprises a report of the QoE measurement.

In some embodiments, if the first terminal device 110 is in RRC_CONNECTED state, the first terminal device 110 transmits, to the first network device 130, the dedicated signaling comprising the report of the QoE measurement.

In some embodiments, if the first terminal device 110 is in RRC_INACTIVE state, the first terminal device 110 may store the report of the QoE measurement. When or after the first terminal device 110 performs RRC Resume procedure, the second terminal device 120 indicates the availability of the report of the QoE measurement to the second network device 140, for example, in the RRCResumeRequest message. Then, the first network device 130 requests the first terminal device 110 to transmit the report of the QoE measurement to the first network device 130.

If the first terminal device 110 is in RRC_IDLE state, the first terminal device 110 may store the report of the QoE measurement. When or after the first terminal device 110 performs RRC Setup procedure, the first terminal device 110 indicates the availability of the report of the QoE measurement to the first network device 130, for example, in the RRCRequest message or RRCSetupComplete message. Then, the first network device 130 requests the first terminal device 110 to transmit the report of the QoE measurement to the first network device 130.

FIG. 6 illustrates a flowchart of a method 600 implemented at a first terminal device in accordance with some embodiments of the present disclosure. For the purpose of discussion, the method 600 will be described from the perspective of the first terminal device 110 with reference to FIG. 1A or 1B.

At block 610, the first terminal device 110 receives, from a second terminal device performing sidelink transmission to the first terminal device 110, second QoE information about the second terminal device. The second QoE information at least comprises an identifier (ID) of the second terminal device.

At block 620, the first terminal device 110 transmits, to a first network device, the second QoE information.

At block 630, the first terminal device 110 transmits, to the first network device, first QoE information about the first terminal device. The first QoE information comprises QoE measurement capability of the first terminal device.

At block 640, the first terminal device 110 receives, from the first network device, first configuration information about a QoE measurement. The first configuration information comprises a first indication indicating the QoE measurement is for the sidelink transmission.

In some embodiments, the first configuration information about the QoE measurement comprises at least one of the following: an ID of the first terminal device, the ID of the second terminal device, a sidelink service type associated with the QoE measurement, an ID identifying the QoE measurement, an application layer measurement configuration for the QoE measurement, or a Radio Access Network (RAN) visible configuration for the QoE measurement.

In some embodiments, the method 600 further comprises transmitting a report of the QoE measurement to the first network device or the second terminal device.

In some embodiments, the method 600 further comprises receiving, from the first network device or the second terminal device, a second indication indicating that the report of the QoE measurement is to be transmitted to the second terminal device; and transmitting the report of the QoE measurement comprises transmitting the report of the QoE measurement to the second terminal device based on the second indication.

In some embodiments, the method 600 further comprises: receiving, from the first network device, a third indication indicating that the report of the QoE measurement is to be transmitted to the first network device; and transmitting the report of the QoE measurement comprises transmitting the report of the QoE measurement to the first network device based on the third indication.

In some embodiments, the second QoE information further comprises a fourth indication of a radio resource control (RRC) state of the second terminal device; and transmitting the report of the QoE measurement comprises transmitting, based on the fourth indication of the RRC state, the report of the QoE measurement to the first network device or the second terminal device.

In some embodiments, the report of the QoE measurement comprises at least one of the following: a first QoE measurement report associated with an application layer measurement configuration for the QoE measurement, or a second QoE measurement report associated with a Radio Access Network (RAN) visible configuration for the QoE measurement.

In some embodiments, the second QoE measurement report comprises one of the following: a sidelink Quality of Service (QOS) flow ID associated with the second QoE measurement report, or a sidelink radio bearer ID associated with the second QoE measurement report.

In some embodiments, the second QoE information further comprises at least one of the following: an ID of a serving cell of the second terminal device, a fourth indication of a radio resource control (RRC) state of the second terminal device, a resource allocation mode of the second terminal device, or a fifth indication indicating whether a signaling radio bearer for a report of the QoE measurement is available between the second terminal device and a second network device serving the second terminal device.

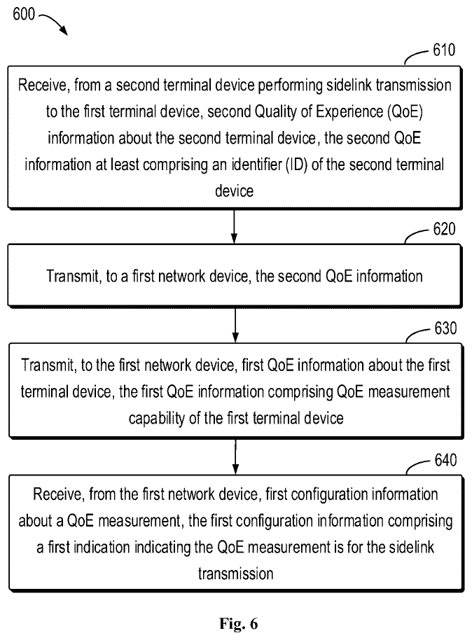

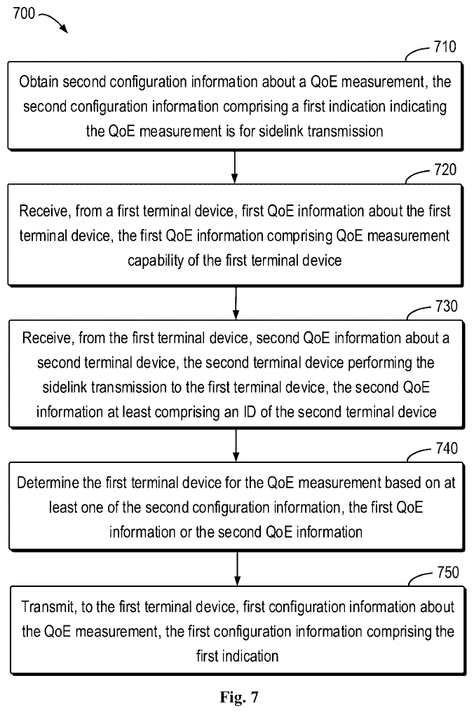

FIG. 7 illustrates a flowchart of a method 700 implemented at a first network device in accordance with some embodiments of the present disclosure. For the purpose of discussion, the method 700 will be described from the perspective of the first network device 130 with reference to FIG. 1A or 1B.

At block 710, the first network device 130 obtains second configuration information about a QE measurement. The second configuration information comprises a first indication indicating the QoE measurement is for sidelink transmission.

At block 720, the first network device 130 receives, from a first terminal device, first QoE information about the first terminal device. The first QoE information comprises QoE measurement capability of the first terminal device.

At block 730, the first network device 130 receives, from the first terminal device, second QoE information about a second terminal device, the second terminal device performing the sidelink transmission to the first terminal device, the second QoE information at least comprising an ID of the second terminal device.

At block 740, the first network device 130 determines the first terminal device for the QoE measurement based on at least one of the second configuration information, the first QoE information or the second QoE information.

At block 750, the first network device 130 transmits, to the first terminal device, first configuration information about the QoE measurement, the first configuration information comprising the first indication.

In some embodiments, the first configuration information about the QoE measurement comprises at least one of the following: an ID of the first terminal device, the ID of the second terminal device, a sidelink service type associated with the QoE measurement, an ID identifying the QoE measurement, an application layer measurement configuration for the QoE measurement, or a Radio Access Network (RAN) visible configuration for the QoE measurement.

In some embodiments, the method 700 further comprises: receiving a report of the QoE measurement from the first terminal device.

In some embodiments, the method 700 further comprises: transmitting one of the following to the first terminal device: a second indication indicating that a report of the QoE measurement is to be transmitted to the second terminal device, or a third indication indicating that the report of the QoE measurement is to be transmitted to the first network device.

In some embodiments, the report of the QoE measurement comprises at least one of the following: a first QoE measurement report associated with an application layer measurement configuration for the QoE measurement, or a second QoE measurement report associated with a Radio Access Network (RAN) visible configuration for the QoE measurement.

In some embodiments, the second QoE measurement report comprises one of the following: a sidelink Quality of Service (QoS) flow ID associated with the second QoE measurement report, or a sidelink radio bearer ID associated with the second QoE measurement report.

In some embodiments, the method 700 further comprises: determining a second network device serving the second terminal device based on the second QoE information about the second terminal device; and transmitting the report of the QoE measurement to the second network device.

In some embodiments, the method 700 further comprises: transmitting the second QoE information about the second terminal device to the second network device.

In some embodiments, the second QoE information further comprises at least one of the following: an ID of a serving cell of the second terminal device, a fourth indication of a radio resource control (RRC) state of the second terminal device, a resource allocation mode of the second terminal device, or a fifth indication indicating whether a signaling radio bearer for a report of the QoE measurement is available between the second terminal device and a second network device serving the second terminal device.

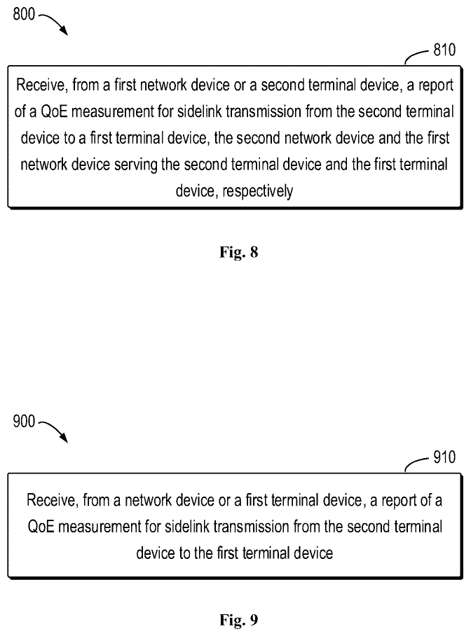

FIG. 8 illustrates a flowchart of a method 800 implemented at a second network device in accordance with some embodiments of the present disclosure. For the purpose of discussion, the method 800 will be described from the perspective of the second network device 140 with reference to FIG. 1A or 1B.

At block 810, the second network device 140 receives, from a first network device or a second terminal device, a report of a QoE measurement for sidelink transmission from the second terminal device to a first terminal device. The second network device and the first network device serve the second terminal device and the first terminal device, respectively.

In turn, the second network device 140 may use the report of the QoE measurement for radio resource optimization.

In some embodiments, receiving the report of the QoE measurement comprises receiving the report of the QoE measurement from the first network device; and the method 800 further comprises: transmitting the report of the QoE measurement to the second terminal device.

In some embodiments, the method 800 further comprises: receiving, from the first network device, second QE information about the second terminal device, the second QoE information at least comprising an identifier (ID) of the second terminal device.

In some embodiments, the second QoE information further comprises at least one of the following: an ID of a serving cell of the second terminal device, a fourth indication of a radio resource control (RRC) state of the second terminal device, a resource allocation mode of the second terminal device, or a fifth indication indicating whether a signaling radio bearer for the report of the QoE measurement is available between the second terminal device and the second network device.

In some embodiments, the report of the QoE measurement comprises a second QoE measurement report associated with a Radio Access Network (RAN) visible configuration for the QoE measurement.

FIG. 9 illustrates a flowchart of a method 900 implemented at a second terminal device in accordance with some embodiments of the present disclosure. For the purpose of discussion, the method 900 will be described from the perspective of the second terminal device 120 with reference to FIG. 1A or 1B.

At block 910, the second terminal device 120 receives, from a network device or a first terminal device, a report of a QoE measurement for sidelink transmission from the second terminal device 120 to the first terminal device.

In turn, the second terminal device 120 may use the report of the QoE measurement for radio resource optimization.

In some embodiments, the network device may only serve the second terminal device.

Alternatively, in some embodiments, the network device may serve both the second terminal device 120 and the first terminal device.

In some embodiments, the method 900 further comprises: transmitting, to the first terminal device, second QoE information about the second terminal device, the second QoE information at least comprising an identifier (ID) of the second terminal device.

In some embodiments, the second QoE information further comprises at least one of the following: an ID of a serving cell of the second terminal device, a fourth indication of a radio resource control (RRC) state of the second terminal device, a resource allocation mode of the second terminal device, or a fifth indication indicating whether a signaling radio bearer for the report of the QoE measurement is available between the second terminal device and the second network device.

In some embodiments, the report of the QoE measurement comprises a second QoE measurement report associated with a Radio Access Network (RAN) visible configuration for the QoE measurement.

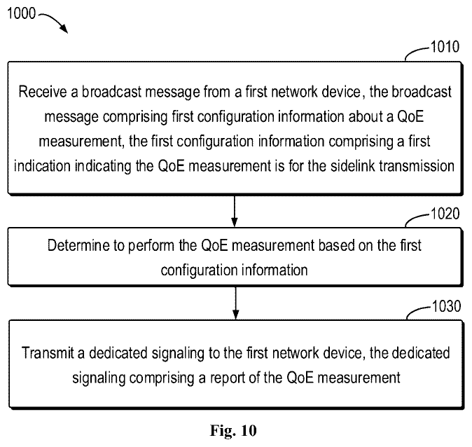

FIG. 10 illustrates a flowchart of a method 1000 implemented at a first terminal device in accordance with some embodiments of the present disclosure. For the purpose of discussion, the method 1000 will be described from the perspective of the first terminal device 110 with reference to FIG. 1A or 1B.

At block 1010, the first terminal device 110 receives a broadcast message from a first network device. The broadcast message comprises first configuration information about a QoE measurement, the first configuration information comprising a first indication indicating the QoE measurement is for the sidelink transmission.

At block 1020, the first terminal device 110 determines to perform the QoE measurement based on the first configuration information.

At block 1030, the first terminal device 110 transmits a dedicated signaling to the first network device. The dedicated signaling comprises a report of the QoE measurement.

In some embodiments, receiving the broadcast message comprises: receiving system information from the first network device, the system information comprising the first configuration information.

In some embodiments, the first configuration information is scrambled by a group Radio Network Temporary Identifier for a group of terminal devices, the group of terminal devices comprising the first terminal device.

FIG. 11 illustrates a flowchart of a method 1100 implemented at a first network device in accordance with some embodiments of the present disclosure. For the purpose of discussion, the method 1100 will be described from the perspective of the first network device 130 with reference to FIG. 1A or 1B.

At block 1110, the first network device 130 transmits a broadcast message. The broadcast message comprises first configuration information about a QoE measurement. The first configuration information comprises a first indication indicating the QoE measurement is for the sidelink transmission.

At block 1120, the first network device 130 receives a dedicated signaling from a first terminal device. The dedicated signaling comprising a report of the QoE measurement.

In some embodiments, transmitting the broadcast message comprises: transmitting system information comprising the first configuration information.

In some embodiments, the first configuration information is scrambled by a group Radio Network Temporary Identifier for a group of terminal devices, the group of terminal devices comprising the first terminal device.

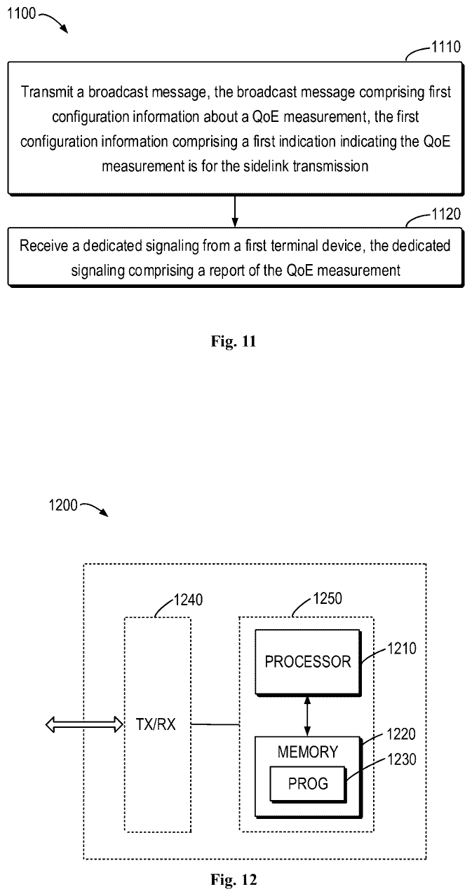

FIG. 12 illustrates a simplified block diagram of an apparatus 1200 that is suitable for implementing embodiments of the present disclosure. The apparatus 1200 can be considered as a further example implementation of the first terminal device 110, the second terminal device 120, the first network device 130 or the second network device 140 as shown in FIG. 1A or 1B. Accordingly, the apparatus 1200 can be implemented at or as at least a part of the first terminal device 110, the second terminal device 120, the first network device 130 or the second network device 140.

As shown, the apparatus 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the apparatus 1200 to operate in accordance with the embodiments of the present disclosure, as discussed herein with reference to FIGS. 1 to 6. The embodiments herein may be implemented by computer software executable by the processor 1210 of the apparatus 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the apparatus 1200, there may be several physically distinct memory modules in the apparatus 1200. The processor 1210 may be of any type suitable to the local technical network, and may include one or more of general purpose computers, special purpose computers, microprocessors, digital signal processors (DSPs) and processors based on multicore processor architecture, as non-limiting examples. The apparatus 1200 may have multiple processors, such as an application specific integrated circuit chip that is slaved in time to a clock which synchronizes the main processor.

In summary, embodiments of the present disclosure provide the following solutions.

Clause 1. A first terminal device, comprising: a processor; and a transceiver coupled to the processor, wherein the processor is configured to: receive, via the transceiver from a second terminal device performing sidelink transmission to the first terminal device, second Quality of Experience (QoE) information about the second terminal device, the second QoE information at least comprising an identifier (ID) of the second terminal device; transmit, via the transceiver to a first network device, the second QoE information; transmit, via the transceiver to the first network device, first QoE information about the first terminal device, the first QoE information comprising QoE measurement capability of the first terminal device; and receive, via the transceiver from the first network device, first configuration information about a QoE measurement, the first configuration information comprising a first indication indicating the QoE measurement is for the sidelink transmission.

Clause 2. The first terminal device of clause 1, wherein the first configuration information about the QoE measurement comprises at least one of the following: an ID of the first terminal device, the ID of the second terminal device, a sidelink service type associated with the QoE measurement, an ID identifying the QoE measurement, an application layer measurement configuration for the QoE measurement, or a Radio Access Network (RAN) visible configuration for the QoE measurement.

Clause 3. The first terminal device of clause 1, wherein the processor is further configured to: transmit a report of the QoE measurement via the transceiver to the first network device or the second terminal device.

Clause 4. The first terminal device of clause 3, wherein the processor is further configured to: receive, via the transceiver from the first network device or the second terminal device, a second indication indicating that the report of the QoE measurement is to be transmitted to the second terminal device; and the processor is configured to transmit the report of the QoE measurement via the transceiver to the second terminal device based on the second indication.

Clause 5. The first terminal device of clause 3, wherein the processor is further configured to: receive, via the transceiver from the first network device, a third indication indicating that the report of the QoE measurement is to be transmitted to the first network device; and the processor is configured to transmit the report of the QoE measurement via the transceiver to the first network device based on the third indication.

Clause 6. The first network device of clause 3, wherein the second QoE information further comprises a fourth indication of a radio resource control (RRC) state of the second terminal device; and the processor is configured to transmit, based on the fourth indication of the RRC state, the report of the QoE measurement via the transceiver to the first network device or the second terminal device.

Clause 7. The first terminal device of clause 3, wherein the report of the QoE measurement comprises at least one of the following: a first QoE measurement report associated with an application layer measurement configuration for the QoE measurement, or a second QoE measurement report associated with a Radio Access Network (RAN) visible configuration for the QoE measurement.

Clause 8. The first terminal device of clause 7, wherein the second QoE measurement report comprises one of the following: a sidelink Quality of Service (QOS) flow ID associated with the second QoE measurement report, or a sidelink radio bearer ID associated with the second QoE measurement report.

Clause 9. The first terminal device of clause 1, wherein the second QoE information further comprises at least one of the following: an ID of a serving cell of the second terminal device, a fourth indication of a radio resource control (RRC) state of the second terminal device, a resource allocation mode of the second terminal device, or a fifth indication indicating whether a signaling radio bearer for a report of the QoE measurement is available between the second terminal device and a second network device serving the second terminal device.

Clause 10. A first network device, comprising: a processor; and a transceiver coupled to the processor, wherein the processor is configured to: obtain, via the transceiver, second configuration information about a Quality of Experience (QoE) measurement, the second configuration information comprising a first indication indicating the QoE measurement is for sidelink transmission; receive, via the transceiver from a first terminal device, first QoE information about the first terminal device, the first QoE information comprising QoE measurement capability of the first terminal device; receive, via the transceiver from the first terminal device, second QoE information about a second terminal device, the second terminal device performing the sidelink transmission to the first terminal device, the second QoE information at least comprising an identifier (ID) of the second terminal device; determine the first terminal device for the QoE measurement based on at least one of the second configuration information, the first QoE information or the second QoE information; and transmit, via the transceiver to the first terminal device, first configuration information about the QoE measurement, the first configuration information comprising the first indication.

Clause 11. The first network device of clause 10, wherein the first configuration information about the QoE measurement comprises at least one of the following: an ID of the first terminal device, the ID of the second terminal device, a sidelink service type associated with the QoE measurement, an ID identifying the QoE measurement, an application layer measurement configuration for the QoE measurement, or a Radio Access Network (RAN) visible configuration for the QoE measurement.

Clause 12. The first network device of clause 10, wherein the processor is further configured to: receive a report of the QoE measurement via the transceiver from the first terminal device.

Clause 13. The first network device of clause 10, wherein the processor is further configured to: transmit one of the following via the transceiver to the first terminal device: a second indication indicating that a report of the QoE measurement is to be transmitted to the second terminal device, or a third indication indicating that the report of the QoE measurement is to be transmitted to the first network device.

Clause 14. The first network device of clause 12 or 13, wherein the report of the QoE measurement comprises at least one of the following: a first QoE measurement report associated with an application layer measurement configuration for the QoE measurement, or a second QoE measurement report associated with a Radio Access Network (RAN) visible configuration for the QoE measurement.

Clause 15. The first network device of clause 14, wherein the second QoE measurement report comprises one of the following: a sidelink Quality of Service (QOS) flow ID associated with the second QoE measurement report, or a sidelink radio bearer ID associated with the second QoE measurement report.

Clause 16. The first network device of clause 12, wherein the processor is further configured to: determine a second network device serving the second terminal device based on the second QoE information about the second terminal device; and transmit the report of the QoE measurement via the transceiver to the second network device.

Clause 17. The first network device of clause 16, wherein the processor is further configured to: transmit the second QoE information about the second terminal device via the transceiver to the second network device.

Clause 18. The first network device of clause 10, wherein the second QoE information further comprises at least one of the following: an ID of a serving cell of the second terminal device, a fourth indication of a radio resource control (RRC) state of the second terminal device, a resource allocation mode of the second terminal device, or a fifth indication indicating whether a signaling radio bearer for a report of the QoE measurement is available between the second terminal device and a second network device serving the second terminal device.

Clause 19. A second network device, comprising: a processor; and a transceiver coupled to the processor, wherein the processor is configured to: receive, via the transceiver from a first network device or a second terminal device, a report of a Quality of Experience (QoE) measurement for sidelink transmission from the second terminal device to a first terminal device, the second network device and the first network device serving the second terminal device and the first terminal device, respectively.

Clause 20. The second network device of clause 19, wherein the processor is configured to receive the report of the QoE measurement via the transceiver from the first network device; and the processor is further configured to transmit the report of the QoE measurement via the transceiver to the second terminal device.

Clause 21. The second network device of clause 19, wherein the processor is further configured to: receive, via the transceiver from the first network device, second QoE information about the second terminal device, the second QoE information at least comprising an identifier (ID) of the second terminal device.

Clause 22. The second network device of clause 21, wherein the second QoE information further comprises at least one of the following: an ID of a serving cell of the second terminal device, a fourth indication of a radio resource control (RRC) state of the second terminal device, a resource allocation mode of the second terminal device, or a fifth indication indicating whether a signaling radio bearer for the report of the QoE measurement is available between the second terminal device and the second network device.

Clause 23. The second network device of clause 19, wherein the report of the QoE measurement comprises a second QoE measurement report associated with a Radio Access Network (RAN) visible configuration for the QoE measurement.

Clause 24. A second terminal device, comprising: a processor; and a transceiver coupled to the processor, wherein the processor is configured to: receive, via the transceiver from a network device or a first terminal device, a report of a Quality of Experience (QoE) measurement for sidelink transmission from the second terminal device to the first terminal device.

Clause 25. The second terminal device of clause 24, wherein the processor is further configured to: transmit, via the transceiver to the first terminal device, second QoE information about the second terminal device, the second QoE information at least comprising an identifier (ID) of the second terminal device.

Clause 26. The second terminal device of clause 25, wherein the second QoE information further comprises at least one of the following: an ID of a serving cell of the second terminal device, a fourth indication of a radio resource control (RRC) state of the second terminal device, a resource allocation mode of the second terminal device, or a fifth indication indicating whether a signaling radio bearer for the report of the QoE measurement is available between the second terminal device and the second network device.

Clause 27. The second terminal device of clause 24, wherein the report of the QoE measurement comprises a second QoE measurement report associated with a Radio Access Network (RAN) visible configuration for the QoE measurement.

Clause 28. A first terminal device, comprising: a processor; and a transceiver coupled to the processor, wherein the processor is configured to: receive a broadcast message via the transceiver from a first network device, the broadcast message comprising first configuration information about a Quality of Experience (QoE) measurement, the first configuration information comprising a first indication indicating the QoE measurement is for the sidelink transmission; determine to perform the QoE measurement based on the first configuration information; and transmit a dedicated signaling via the transceiver to the first network device, the dedicated signaling comprising a report of the QoE measurement.

Clause 29. The first terminal device of clause 28, wherein the processor is configured to receive the broadcast message via the transceiver by: receiving system information via the transceiver from the first network device, the system information comprising the first configuration information.

Clause 30. The first terminal device of clause 28, wherein the first configuration information is scrambled by a group Radio Network Temporary Identifier for a group of terminal devices, the group of terminal devices comprising the first terminal device.

Clause 31. A first network device, comprising: a processor; and a transceiver coupled to the processor, wherein the processor is configured to: transmit a broadcast message via the transceiver, the broadcast message comprising first configuration information about a Quality of Experience (QoE) measurement, the first configuration information comprising a first indication indicating the QoE measurement is for the sidelink transmission; and receive a dedicated signaling via the transceiver from a first terminal device, the dedicated signaling comprising a report of the QoE measurement.

Clause 32. The first network device of clause 31, wherein the processor is configured to transmit the broadcast message via the transceiver by: transmitting, via the transceiver, system information comprising the first configuration information.

Clause 33. The first network device of clause 31, wherein the first configuration information is scrambled by a group Radio Network Temporary Identifier for a group of terminal devices, the group of terminal devices comprising the first terminal device.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first terminal device, comprising:
at least one memory; and
at least one processor coupled with the at least one memory and configured to cause the first terminal device to:
receive, via sidelink communication from a second terminal device, second quality of experience (QoE) information about the second terminal device, the second QoE information at least comprising an identifier (ID) of the second terminal device;
transmit the second QoE information;
transmit first QoE information about the first terminal device, the first QoE information comprising QoE measurement capability of the first terminal device; and
receive first configuration information about a QoE measurement, the first configuration information comprising a first indication indicating the QoE measurement is for the sidelink communication.

2. The first terminal device of claim 1, wherein the first configuration information about the QoE measurement comprises at least one of:
an ID of the first terminal device,
the ID of the second terminal device,
a sidelink service type associated with the QoE measurement,
an ID identifying the QoE measurement,
an application layer measurement configuration for the QoE measurement, or
a radio access network (RAN) visible configuration for the QoE measurement.

3. The first terminal device of claim 1, wherein the at least one processor is further configured to cause the first terminal device to:
transmit a report of the QoE measurement to a first network device or the second terminal device.

4. The first terminal device of claim 3, wherein the at least one processor is further configured to cause the first terminal device to:
receive, from the first network device or the second terminal device, a second indication indicating that the report of the QoE measurement is to be transmitted to the second terminal device; and
transmit the report of the QoE measurement to the second terminal device based on the second indication.

5. The first terminal device of claim 3, wherein the at least one processor is further configured to cause the first terminal device to:
receive, from the first network device, a third indication indicating that the report of the QoE measurement is to be transmitted to the first network device; and
transmit the report of the QoE measurement to the first network device based on the third indication.

6. The first terminal device of claim 3, wherein:
the second QoE information further comprises a fourth indication of a radio resource control (RRC) state of the second terminal device; and
the at least one processor is further configured to cause the first terminal device to transmit, based at least in part on the fourth indication of the RRC state, the report of the QoE measurement to the first network device or the second terminal device.

7. The first terminal device of claim 3, wherein the report of the QoE measurement comprises at least one of:
a first QoE measurement report associated with an application layer measurement configuration for the QoE measurement, or
a second QoE measurement report associated with a radio access network (RAN) visible configuration for the QoE measurement.

8. The first terminal device of claim 7, wherein the second QoE measurement report comprises one of:
a sidelink quality of service (QoS) flow ID associated with the second QoE measurement report, or
a sidelink radio bearer ID associated with the second QoE measurement report.

9. The first terminal device of claim 1, wherein the second QoE information further comprises at least one of:
an ID of a serving cell of the second terminal device,
a fourth indication of a radio resource control (RRC) state of the second terminal device,
a resource allocation mode of the second terminal device, or
a fifth indication indicating whether a signaling radio bearer for a report of the QoE measurement is available between the second terminal device and a second network device serving the second terminal device.

10. A first network device, comprising:
at least one memory; and
at least one processor coupled with the at least one memory and configured to cause the first network device to:
obtain, second configuration information about a quality of experience (QoE) measurement, the second configuration information comprising a first indication indicating the QoE measurement is for sidelink transmission;
receive, from a first terminal device, first QoE information about the first terminal device, the first QoE information comprising QoE measurement capability of the first terminal device;
receive, from the first terminal device, second QoE information about a second terminal device, the second QoE information comprising at least an identifier (ID) of the second terminal device;
determine the first terminal device for the QoE measurement based at least in part on at least one of the second configuration information, the first QoE information or the second QoE information; and
transmit, to the first terminal device, first configuration information about the QoE measurement, the first configuration information comprising the first indication.

11. The first network device of claim 10, wherein the first configuration information about the QoE measurement comprises at least one of:
an ID of the first terminal device,
the ID of the second terminal device,
a sidelink service type associated with the QoE measurement,
an ID identifying the QoE measurement,
an application layer measurement configuration for the QoE measurement, or
a radio access network (RAN) visible configuration for the QoE measurement.

12. The first network device of claim 10, wherein the at least one processor is further configured to cause the first network device to:
receive a report of the QoE measurement from the first terminal device.

13. The first network device of claim 12, wherein the at least one processor is further configured to cause the first network device to:
determine a second network device serving the second terminal device based at least in part on the second QoE information about the second terminal device; and
transmit the report of the QoE measurement to the second network device.

14. The first network device of claim 13, wherein the at least one processor is further configured to cause the first network device to:
transmit the second QoE information about the second terminal device to the second network device.

15. A second network device, comprising:
at least one memory; and
at least one processor coupled with the at least one memory and configured to cause the second network device to:
receive, from a first network device or a second terminal device, a report of a quality of experience (QoE) measurement for sidelink transmission from the second terminal device to a first terminal device, the second network device serving the second terminal device and the first network device serving the first terminal device.

16. A method performed by a first terminal device, the method comprising:
receiving, via sidelink communication from a second terminal device, second quality of experience (QoE) information about the second terminal device, the second QoE information at least comprising an identifier (ID) of the second terminal device;
transmitting the second QoE information;
transmitting first QoE information about the first terminal device, the first QoE information comprising QoE measurement capability of the first terminal device; and
receiving first configuration information about a QoE measurement, the first configuration information comprising a first indication indicating the QoE measurement is for the sidelink communication.

17. The method of claim 16, wherein the first configuration information about the QoE measurement comprises at least one of:
an ID of the first terminal device,
the ID of the second terminal device,
a sidelink service type associated with the QoE measurement,
an ID identifying the QoE measurement,
an application layer measurement configuration for the QoE measurement, or
a radio access network (RAN) visible configuration for the QoE measurement.

18. The method of claim 16, further comprising:
transmitting a report of the QoE measurement to a first network device or the second terminal device.

19. The method of claim 18, further comprising:
receiving, from the first network device or the second terminal device, a second indication indicating that the report of the QoE measurement is to be transmitted to the second terminal device; and
transmitting the report of the QoE measurement to the second terminal device based on the second indication.

20. The method of claim 18, further comprising:
receiving, from the first network device, a third indication indicating that the report of the QoE measurement is to be transmitted to the first network device; and
transmitting the report of the QoE measurement to the first network device based on the third indication.
